(19) United States
(12) Patent Application Publication
(10) Pub. No.: US 2018/0350264 A1
(43) Pub. Date: Dec. 6, 2018

(54) METHODS AND SYSTEMS FOR PROVIDING NON-AUDITORY FEEDBACK TO USERS

(71) Applicant: XEROX CORPORATION, Norwalk, CT (US)

(72) Inventors: Aritra Dhar, Konnagar (IN); Kuldeep Yadav, Gurgaon (IN)

(21) Appl. No.: 15/607,804

(22) Filed: May 30, 2017

(51) Int. Cl. G09B 21/00; G10L 21/18

(52) U.S. Cl. CPC G09B 21/003; G10L 21/18

(57) ABSTRACT

The present disclosure discloses methods and systems for providing non-auditory feedback to users related to sensitive information. The method includes receiving one or more characters on a first computing device. Each character is encoded into a braille code, the braille code is represented by a matrix of pre-defined size. For each character, the braille code is divided into a first part and a second part. A first vibration output is provided corresponding to the first part of braille code via the first computing device and a second vibration output is provided corresponding to the second part of the braille code via a second computing device. The combination of the first vibration output and the second vibration output is sensed by a user to recognize each character of the one or more characters.

### TECHNICAL FIELD

The presently disclosed subject matter relates to feedback systems, more particularly to methods and systems for providing non-auditory feedback to users.

### BACKGROUND

High proliferation of smartphones in last two decades has made access to information as well as multitude of different services easier than before. Similarly, there have been increasing adoptions of wearable devices that work with smartphones to provide different set of services, i.e., gestural input/interaction, wellness tracking, etc. Smartphones have become pervasive and it is unimaginable to complete many of our day-to-day tasks without the smartphones. Smartphones have also penetrated into lives of diverse set of users and as a result, many visually impaired people are also using them for different kinds of information access scenarios. The visually impaired people constitute a significant portion of population. There are approximately 285 million visually impaired people in the world, of which 246 million (approximately) have low vision and 39 million (approximately) are blind. However, current set of smartphones and wearable devices are designed for clear-sighted people where most of the interactions happen using visual modalities, i.e., a touch screen.

In recent years smartphone makers and smartphone operating systems have started providing assistive technologies for visually impaired users. All these technologies rely on talkback feature. The talkback feature speaks out loud all the activities that a visually impaired user performs on the smartphone. For example, the talkback feature speaks out when the user taps an icon of a particular application, inputs an alphabet or performs any other activity on the phone. But the talkback feature is often inefficient and confusing because of noisy surroundings or requires lot of attention. Moreover talkback feature is insufficient in activities such as phone dial and message typing. Another shortcoming with the talkback feature is that it may be practically unusable in scenarios where the user wants to deal with sensitive or private information. Few examples of such scenarios are entering OTP, PIN, password or any sensitive information for financial transactions or other services. Since the talkback features works on speak out mechanism, therefore, it is not desirable to have the sensitive information leaked in this manner. Using headphone is a trivial solution but is infeasible as it blocks out ambient sounds on which visually impaired users depend for navigation and interaction. In all, existing solutions are severely limited in their functionalities as well as it cannot be used in many social and environmental conditions such as noisy places. Moreover, the existing solutions are not privacy friendly.

Many reports suggest that there have been disparity in employment for visually impaired people and they get very less employment opportunities. According to “Blind Adults in America: Their Lives and Challenges,” only 19% of legally blind adult Americans (18 years of age and older) were employed. According to the NLTS2 data reports, 28.3% (wave 1) and 28.4% (wave 2) of out-of-school youth with visual impairments were employed at the time they were interviewed. These days the visually impaired people actively use social networks such as Facebook and WhatsApp using their smartphones. For example, the visually impaired people use Facebook and actively post messages and interact with their friends. Hence, it is of utmost importance to enable seamless technology experience for visually impaired people so that they can get to use the services, which have become pervasive for sighted people.

There have been research works on enabling interfaces for braille or gesture-based input using smartphones with subsequent auditory feedback. In the last few years, wearable devices are becoming mainstream where such devices can be paired with smartphones to provide gestural inputs, which may be one of the alternative to touch-screen based interaction provided by smartphones. For example, if a visually impaired person enters a character or a string using such interfaces, smartphone or a wearable device speaks-out entered characters for validation purpose. However, many times auditory feedback is not possible due to environmental conditions i.e. noisy feedback or privacy concerns (i.e., messages, chat) as well sensitive nature of information (i.e., passwords, PIN, etc.) as discussed above. Using headphone is one of the solutions to minimize leakage of information but is infeasible as it blocks out other ambient sounds, which visually impaired people depend on for navigation and interaction. Hence, there is a need for the investigation of new interfaces and techniques, which can provide them implicit feedback or output to the users in different environmental and social settings.

### SUMMARY

According to aspects illustrated herein, a method for providing non-auditory feedback to users is disclosed. The method includes receiving one or more characters on a first computing device. Each character is encoded into a braille code, the braille code is represented by a matrix of pre-defined size. For each character, the braille code is divided into a first part and a second part. A first vibration output is provided corresponding to the first part of braille code via the first computing device and a second vibration output is provided corresponding to the second part of the braille code via a second computing device. The combination of the first vibration output and the second vibration output is sensed by a user to recognize each character of the one or more characters.

According to another aspect of the present disclosure, a system having a first computing device and a second computing device is disclosed, the second computing device is in communication with the first computing device. The first computing device includes a user interface and a feedback application running on the first computing device. The user interface is configured to receive one or more characters representing sensitive information related to a user. The feedback application is configured to encode each character into a braille code, wherein the braille code is represented by a matrix; for each character, convert the braille code into a first part and a second part; provide a first vibration output corresponding to the first part of braille code via the first computing device; and provide a second vibration output corresponding to the second part of the braille code via a second computing device, wherein the combination of the first vibration output and the second vibration output is sensed by the user to validate each character of the one or more characters.

According to yet another aspect of the present disclosure, a method for providing non-auditory feedback for each character of sensitive information is disclosed. The method includes encoding each character of the sensitive information into a binary braille code. Then, for each character, the braille code is divided into a first part and a second part. Thereafter, a first vibration pattern is generated corresponding to the first part of braille code and a second vibration pattern is generated for the second part of braille code. The first vibration pattern is provided to the user via a first computing device and the second vibration pattern is provided via a second computing device. The first vibration pattern and the second vibration pattern enables the user to recognize each character of the sensitive information.

### BRIEF DESCRIPTION OF THE DRAWINGS

FIGS. 1A-1D show exemplary environments, in which various embodiments of the disclosure may be practiced.

FIG. 2 is a block diagram illustrating various system elements of an exemplary computing device.

FIG. 3 is a user interface indicating one or more vibration modes.

FIGS. 4A-4B illustrate an exemplary input character and corresponding output as generated according to the current disclosure.

FIG. 5 is a flowchart illustrating an exemplary method for providing non-auditory feedback to users.

### DESCRIPTION

The following detailed description is provided with reference to the figures. Exemplary, and in some case preferred, embodiments are described to illustrate the disclosure, not to limit its scope, which is defined by the claims. Those of ordinary skill in the art will recognize a number of equivalent variations in the description that follows.

### Non-Limiting Definitions

In the disclosure herein after, one or more terms are used to describe various aspects of the present subject matter. For better understanding of the subject matter, a few definitions are provided herein for better understating of the present disclosure.

The term “computing device” refers to an electronic device having the capability to process, store, send or receive data or the like. In the context of the disclosure, the computing device provides non-auditory feedback to users, especially visually impaired users. Various examples of the computing device include, but not limited to, a mobile phone, a tablet, a PDA (personal digital assistant), a smart watch or any equivalent devices. The present disclosure further includes a first computing device and a second computing device.

The term “feedback” refers to a way of telling users whether one or more characters as input by the user or received are correct. The feedback may be in the form of one or more vibration patterns. The feedback may be provided to the user via two computing devices—the first computing device such as a smart phone, and the second computing device, a smart watch, for example. The feedback is provided via a feedback application that runs on the first computing device and/or the second computing device.

The “sensitive information” refers to the critical information of the users such as PIN, password, user id, ATM pin, one time password (OTP), bank account information, or the like. The sensitive information includes one or more characters such as alphabets, numbers, symbols or a combination of these. The characters are generally a part of sensitive information or critical information. The sensitive information may interchangbly be used with critical information, private information, or confidential information of the users.

The term “braille symbol” represents a matrix of standard size, such as 3×2, and the matrix includes dots with blank or filled. The blank dot represents “0,” while the filled dot represents “1.” The braille symbol is understood by the visually impaired users. The braille symbol may interchangbly be used with the phrase braille code.

### Overview

Talkback is a tool that provides feedback to users especially visually impaired users. For example, if a user receives an email, the talkback features speaks out content of the email for the user and so on. In environments where security and privacy of information is important, talkback feature is not very helpful. The talkback feature speaks out the critical or sensitive information which may ultimately lead to leakage of such critical data in public and social environments. Therefore, it is important to provide ways that enable users to provide feedback such that no sensitive information goes out from the user and the sensitive information remains with the user or stays associated with the user device. The present disclosure thus provides methods and systems to provide implicit tactile feedback to users, but not limited to, completely visually impaired users or partially visually impaired users. The tactile feedback is in the form of vibrations or other physical output. The tactile feedback is very helpful in noisy, public and social environments.

### Exemplary Environment

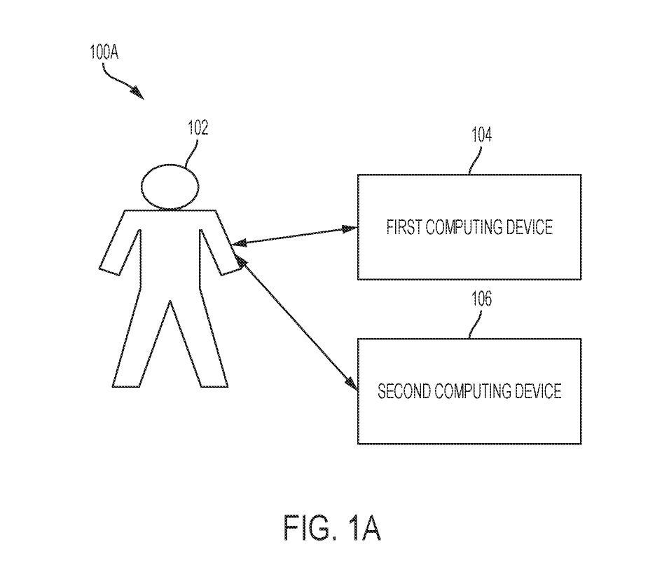

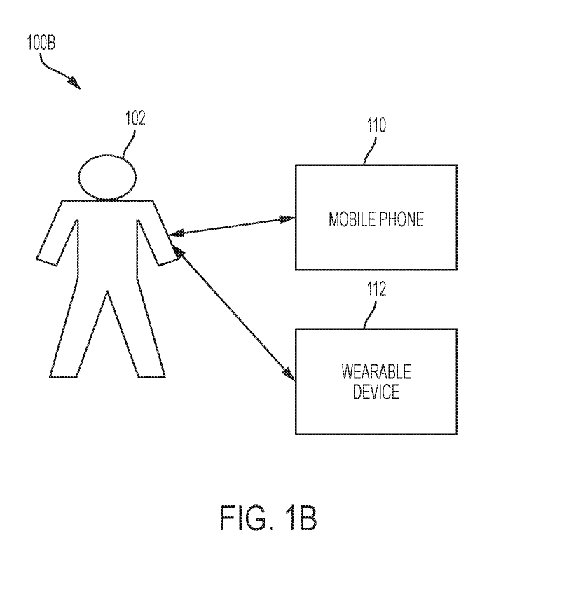

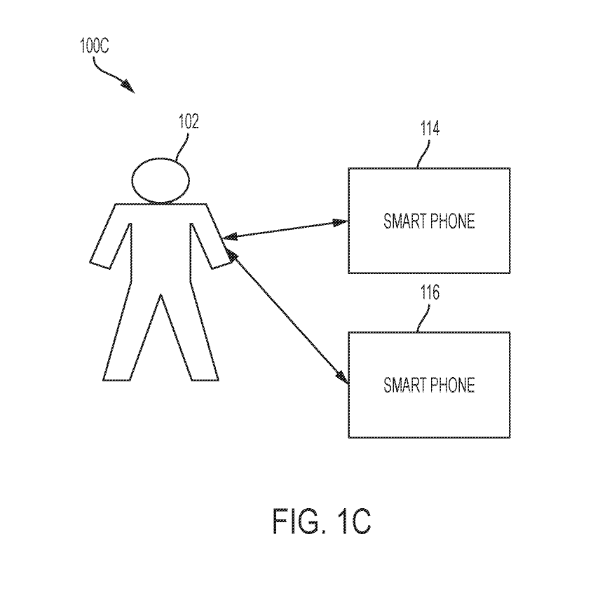

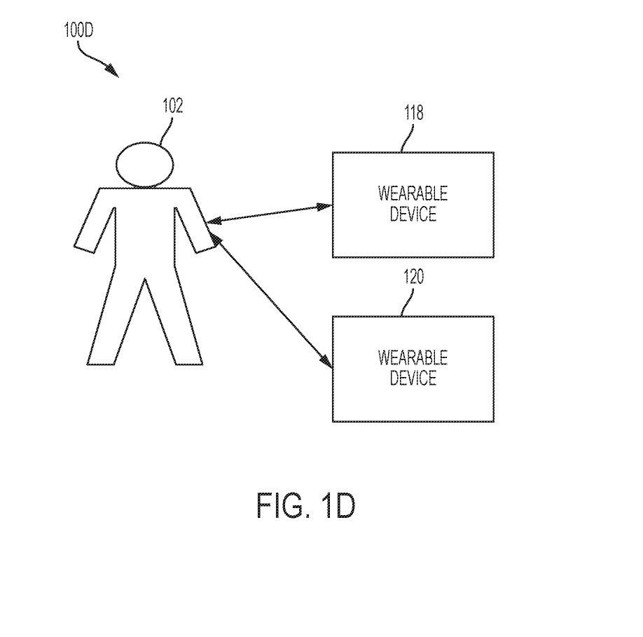

FIG. 1A shows an exemplary environment 100A in which various embodiments of the disclosure can be practiced. The environment 100A includes a user 102, a first computing device 104 and a second computing device 106. The first computing device 104 communicates with the second computing device 106 via a suitable communication protocols. One such popular example for communication is via Bluetooth. The user 102 may be a user with normal vision. While the user 102 may be completely a visually impaired user or a partially impaired user. The first computing device 104 and the second computing device 106 are associated with the user 102. The first computing device 104 and the second computing device 106 are typically used by the user 102 for his daily tasks such email, surfing, chatting, social networking or a combination thereof. Examples of the first computing device 104 and the second computing device 106 may include, but are not limited to, a mobile phone, a smart watch, a tablet computer, a laptop, a wearable smart headset, an ear-mounted video camera, a wearable smart eyewear, a personal digital assistant (PDA), a notebook computer, a smart fitness band, and so forth.

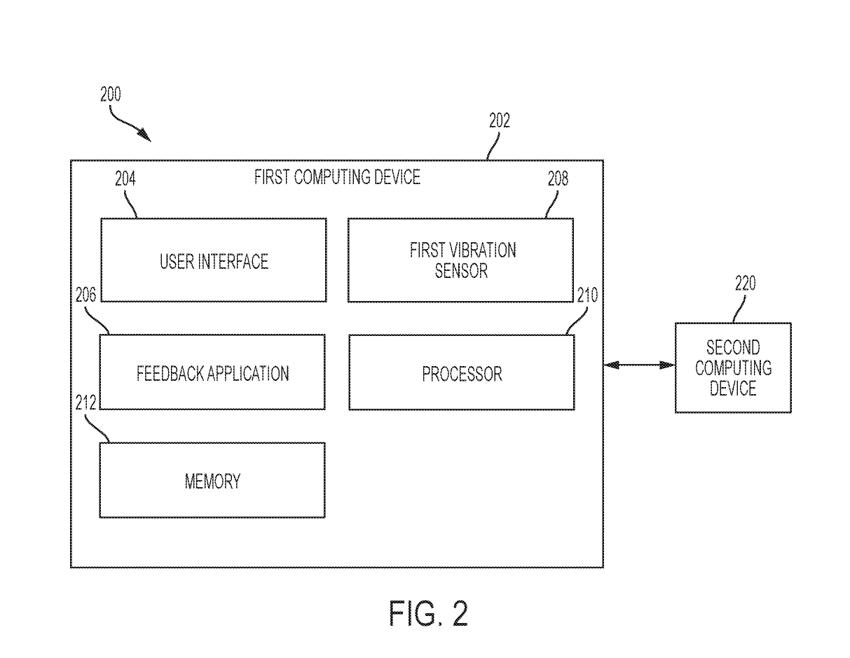

As shown, the user 102 uses a computing device, for example, the first computing device 104. In the context of the current disclosure, the first computing device 104 receives the sensitive information. The sensitive information may be received in the form of a text message, an email, a chat message or a combination thereof. Other than this, the sensitive information may be input by the user 102. The sensitive information includes one or more characters such as english alphabets, numbers, symbols, or a combination of these. In some examples, the sensitive information may include gesture based inputs, or the like. The sensitive information may be a PIN, password, one time password, bank information, or the like. The sensitive information may be of any length such as two characters, four characters, or the like. For example, the sensitive information may represent a numeric PIN 7614. In other example, sensitive information may represent a password a@4567. The first computing device 104 passes the sensitive information to a feedback application (see FIG. 2) running on the first computing device 104. The feedback application converts each character of the sensitive information into braille symbol and the braille symbol is represented through vibrational patterns/feedback, i.e., non-auditory feedback. The vibrational patterns are generated from the braille symbol. Braille encodes characters using two surface pattern: embossed and flat. For embossed patterns, long vibration may be used, while short vibration may be used for flat surface pattern.

The vibrational feedback helps the user (i) validating whether the characters as input by the user are correct. The vibrational feedback also helps the user recognize the characters as received. In this manner, the present disclosure provides a secure and safe way of communicating sensitive information to the users. More details related to the working will be discussed in FIGS. 2-5.

As shown in environment 100B of FIG. 1B, the first computing device 104 and the second computing device 106 may be different type. For example, the first computing device 104 may be a mobile phone 110, while the second computing device 106 may be a wearable device 112. While in some cases, the first computing device 104 and the second computing device may be of same type. For example, as depicted in environment 100C of FIG. 1C, where the first computing device is a smart phone 114, while the second computing device is also a smart phone 116. As further seen in environment 100D of FIG. 1D, the first computing device is a wearable device 118, while the second computing device is a wearable device 120.

### Exemplary System

Looking at the current technology trends, it is seen that computing devices such as mobile phones are very popular among users, be it a user with normal vision, completely impaired users or partially impaired users. This is due to a number of features provided by phone manufacturers for all types of users. Similar to users with clear sighted vision, impaired users also use mobile phones comfortably, but the problem comes when impaired users write messages, emails, or chat messages, it is difficult to see typos or errors while writing. Similarly, when the users receive messages, emails or chat messages, specially containing sensitive information, it is not safe to speak out such sensitive information. Therefore, it is very important to have a feedback mechanism that can validate the input provided by the user as well as communicate sensitive information in a private manner, without disclosing it publicly or in social environments. The tactile feedback is hard to miss even in a noisy surrounding and can be achieved without using additional devices.

FIG. 2 is a block diagram 200 illustrating various system elements of an exemplary computing device such as a first computing device 202 and a second computing device 220. As shown, the first computing device 202 primarily includes a user interface 204, a feedback application 206, a vibration sensor 208, a processor 210 and a memory 212. The processor 210 and the memory 212 are standard modules. Each of the elements 204, 206, 208, 210 and 212 communicate with each other via a communication bus or any suitable protocols. The first computing device 202 communicates with the second computing device 220 via suitable known techniques. The first computing device 202 and the second computing device 220 are paired through technologies such as Bluetooth, or the like.

For better results and fast results, the disclosure is implemented using two computing devices such as the first computing device 202 and the second computing device 220. For a person skilled in the art, it is understood that the disclosure may be implemented for a single computing device such the first computing device 202 or the second computing device 220. Each of the computing devices 202 and 220 have similar structural and operational details as known in the art and thus any such details do not interfere while implementing the present disclosure.

The user interface 204 enables the user to receive or input one or more characters. The user interface 204 may be a touch-based user interface or any other user interface that enables the user to receive or input the one or more characters. The one or more characters include, but not limited to, an alphabet, a number, a symbol, or combination of these. The characters represent sensitive information such as a password, a PIN, an OTP, or the like.

The processor 210 triggers the feedback application 206 upon receiving one or more characters and further communicates with other modules such as 204, 206, 208 and 212 for implementing the current disclosure. The memory 212 stores braille codes for various alphabets, numerals, or a combination thereof. The information is stored in any desired format as known or later developed technology.

The feedback application 206 runs on the first computing device 202 and provides implicit feedback to the user by communicating the input message or the received message through vibration. The feedback application 206 is activated by the user or may be deactivated by the user as and when required. For example, the feedback application may be activated by the user when the user deals with sensitive information or private information such as inputting an OTP. While, the feedback application may be deactivated by the user when the user performs normal activities such as writing emails, chatting or the like. The feedback application 206 receives each character as input or received as a part of a text message, an email, or a chat message. The feedback application 206 encodes each character into a corresponding braille symbol. The braille symbol is typically represented into a matrix of predefined format such as 3×2, where the matrix has three rows and two columns. Each row and column includes a value as blank (i.e., 0), or a dot (i.e., 1). Braille symbols are represented in a 3×2 matrix where each cell can be either flat (i.e., 0), or embossed dot (i.e., 1), which provides touch sensation. The feedback application 206 converts or divides each encoded binary symbol into two parts, i.e., a first part and a second part. The first part is represented by a 3×1 matrix and the second part is also represented by 3×1 matrix. The first part and the second part collectively represent a character as input or received.

The feedback application 206 then converts the first part of the binary code into a first vibration output of a first intensity and the second part of the binary code into a second vibration output of a second intensity. The first part of the binary code is provided to the user via the first computing device and the second part of the binary code is provided via the second computing device. The first vibration output and the second vibration output may be associated with one or more properties such as, but not limited to, intensity, amplitude, an interval between at two vibration outputs. Further, the user may set these associated properties of the first vibration output and the second vibration output via the user interface 204. The first vibration output is provided by the first vibration sensor 208 and the second vibration output is provided by a second vibration sensor (although not shown) The vibration intensity depends on the a combination of “0s” and “1s” in the first part and the second part of the binary braille code.

The first vibration output may be transmitted to the second computing device 220 via the first computing device 202 over the Bluetooth channel. In some cases, the second vibration output may be transmitted to the second computing device 220 via the first computing device 202 over the Bluetooth channel.

Further, each of the first pre-defined intensity vibration and the second pre-defined intensity vibration is provided for a pre-defined duration. For example, one second, two seconds, and so forth, via the first vibration sensor 208. In some embodiments, the first intensity vibration is provided by the first vibration sensor 208 for a longer period than the second intensity vibration. For example, a vibration output of “0” may be provided for 1 second and a vibration output for “1” in the binary braille code may be provided for 3 seconds.

Based on the combination of the first vibration output and the second vibration output, the user identifies the character. The feedback application repeats the steps of braille conversion and outputting vibration for each character of the sensitive information. For example, if the sensitive information includes four characters, then the process is repeated four times and in this manner, the user identifies each character of the sensitive information. The vibration confirms the correctness or accuracy of the characters as input or received by the user on the first computing device 202. The varying vibration output using the combination of computing devices (i.e., the first computing device 202 and the second computing device 220) is a stronger differentiating factor particularly for grasping sensitive information in case of visually impaired people. These vibrations are strong and last for a small duration (few milliseconds) to provide fast, non-auditory feedback. Each of these vibrations are separated by few millisecond intervals.

In some cases, Application Program Interfaces such as Google wear API may be used to relay commands and vibrational patterns from the first computing device 202 (mobile phone) to the paired second computing device 220 (smart watch). The feedback application 206 can pair up with any smart watch running android operating system and can divert specific haptic feedback to the smart watch.

Though FIG. 2 is discussed with respect to the first computing device 202, but it is understood that the disclosure may be implemented for the second computing device 220. And further, FIG. 2 is discussed for a single character for better understanding and but the disclosure may be implemented for any number of characters.

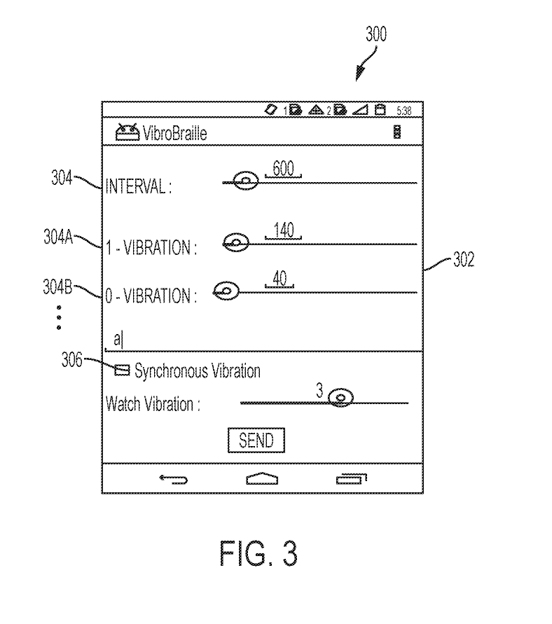

FIG. 3 is an exemplary snapshot 300 of a user interface 302 of a computing device such as the first computing device 202 or the second computing device 220. The user interface 302 shows various options such as 304 and 306 related to vibration output. As shown, the option of internal vibration 304 and synchronous vibration 306 are shown in the user interface 302. Exemplary vibration intensity related to a code “1” (i.e., embossed dot) is shown by 304A, while the vibration intensity related to a binary value “0” (empty dot) is shown as 304B. The user may set these associated properties of the first vibration output and the second vibration output via the user interface 302. For example, the user may set an interval duration, i.e., a length between vibrations in milliseconds, a vibration duration, i.e., a duration of vibrations corresponding to braille symbols (or dots), and so forth.

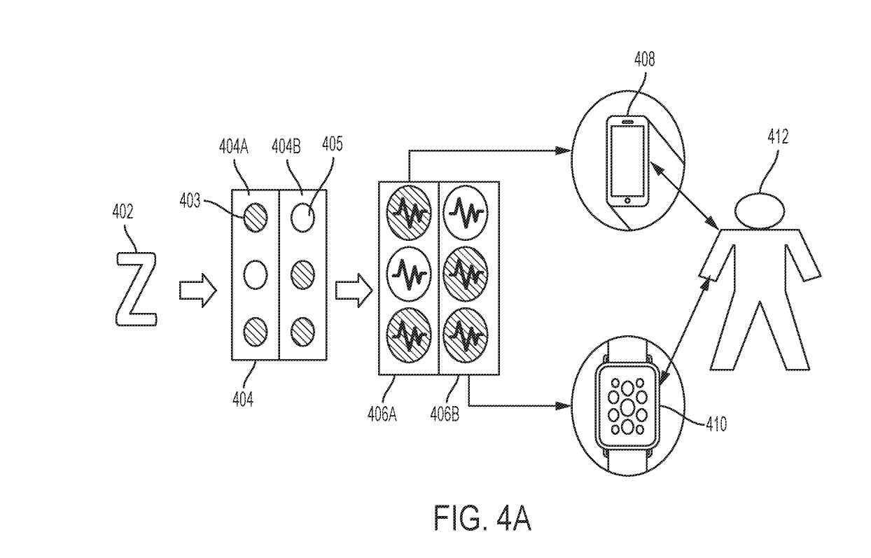

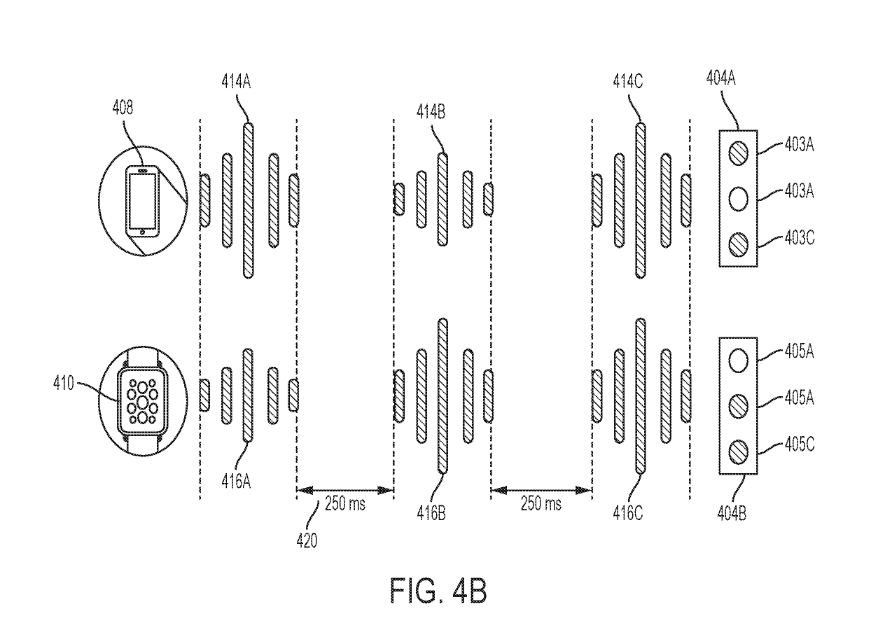

FIGS. 4A-4B show an exemplary scenario, where a user 412 such as a visually impaired user provides an input character for example, “Z” (marked a 402). The binary braille code corresponding to the input character 402 is shown by a matrix of size 3×2 as indicated by 404. The matrix 404 includes a first part 404A and a second part 404B. The first part 404A is represented by 3×1 matrix, while the second part 404B is represented by 3×1 matrix. The braille code further is represent by a blank dot such as 405 and a filled dot as 403. The blank dot represents “0,” while the filled dot represents “1.” The matrix 404 part is then represented into vibration patterns such as 406A and 406B corresponding to the first part 404A and the second part 404B, respectively. The vibration pattern is 406A is sent to the user 412 via a smart phone 408, while the pattern 406B is sent via the smart watch 410.

FIG. 4B shows various vibration patterns corresponding to a character. As shown, a character is represented by a braille code, i.e., a first part 404A and the second part 404B. Each dot 403A, 403B, and 403C is represented by vibration patterns such 414A, 414B and 414C, respectively. Similarly, each dot 405A, 405B, and 405C is represented by 416A, 4168 and 416C, respectively. As shown, the vibration patterns are generated by a few milliseconds as indicated by 420.

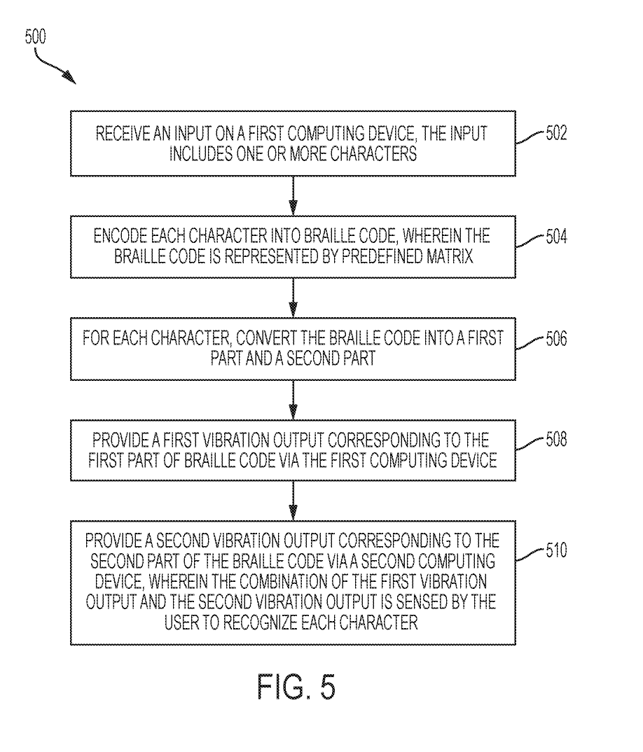

FIG. 5 is a flowchart 500 for providing feedback to users such as visually impaired users. The feedback is provided in the form one or more vibrations and the vibrational feedback ensures accuracy of the sensitive information as input by the user as well as minimizes leakage of sensitive information as received. The method is applicable for scenarios (i) where the user inputs sensitive information such as PIN, passwords, OTPs, etc., on a computing device and/or (ii) the user receives the sensitive information on a computing device in the form of an email, a text message, a chat message or a combination of these.

Initially the method starts when an input in the form of one or more characters is received by a first computing device at 502. The one or more characters are input by a user, while the one or more characters are received in the form of an email, for example. Especially, the one or more characters represent private or confidential data of the user. For example, the one or more characters may represent a PIN, a password, one time password, or any other sensitive information of the user. At 504, each of the received characters are encoded into a binary braille code. The braille code is represented by a pre-defined matrix of size 3×2. The binary braille code is divided into two parts: a first part and a second part at 506. Each part may be represented by 3×1 matrix. From braille codes, vibration patterns are generated, i.e., a first vibration pattern/output and a second vibration pattern/output is generated corresponding to the first part and the second part.

At 508, a first vibration output is provided to the user corresponding to the first part of the braille symbol and similarly, a second vibration output is provided to the user corresponding to the second part of the braille symbol at 510. The first vibration output is provided via the first computing device, while the second vibration output is provided via the second computing device. The combination of the first vibration output and the second vibration output is sensed by the user to recognize each character. The first vibration output may be of different intensity than the second vibration output.

For example, if the user enters a character A, the entered character is converted into its 6-bit binary braille version (e.g., ‘A’ translates to a bit pattern 100000). Here, the first half of the bit-pattern (e.g., “100” in ‘a’) vibrates on the first computing device such as a mobile device, while the second half (e.g., “000” in ‘a’) is relayed on the second computing device a smart-watch, for example.

The vibrations may be configured in three different ways such as interval duration, vibration duration and synchronous vibration. In the interval vibration, the length of the intervals between vibrations is in milliseconds. In the vibration duration, duration of vibrations of braille symbols is important. For example, embossed surface vibrates for longer duration and flat surface for shorter duration. In the synchronous vibration, the mode enables the application to send the vibration to two computing devices such as a watch and a phone simultaneously. By default, the watch vibrates first and then the phone vibrates.

The present disclosure discloses methods and systems for providing implicit feedback to users such as visually impaired users. The primary aim of the disclosure is to provide sensitive information to the users such that the sensitive information is undetectable to others (i.e., through vibration). For example, the methods and systems are beneficial when users input sensitive information on their associated computing devices and/or receive sensitive information. The vibration output is usually hard to miss even in noisy surroundings and is thus beneficial. In all, the present disclosure provides a safe environment when the user wishes to deal with sensitive information. The disclosed methods and systems provide easy learning curve for the beginner blind users, fast recognition of braille symbols with least number of typos and ability to seamlessly integrate with existing application ecosystem. The methods and systems may be used for training normal vision users. Additionally, the methods and systems may be used for kids to learn alphabets.

For a person skilled in the art, it is understood that the use of phrase(s) “is,” “are,” “may,” “can,” “could,” “will,” “should,” or the like is for understanding various embodiments of the present disclosure and the phrases do not limit the disclosure or its implementation in any manner.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “merging,” or “decomposing,” or “extracting,” or “modifying,” or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method, comprising:
receiving one or more characters on a first computing device;
encoding each character into a braille code, wherein the braille code is represented by a matrix of pre-defined size;
for each character, dividing the braille code into a first part and a second part;
providing a first vibration output corresponding to the first part of braille code via the first computing device; and
providing a second vibration output corresponding to the second part of the braille code via a second computing device, wherein the combination of the first vibration output and the second vibration output is sensed by a user to recognize each character of the one or more characters.

2. The method of claim 1, wherein the one or more characters are input by the user on the first computing device.

3. The method of claim 1, wherein the one or more characters are received in the form of: a text message, an email and a chat message.

4. The method of claim 1, wherein the one or more characters represent sensitive information related to the user.

5. The method of claim 1, wherein the one or more characters comprise at least one of an alphabet, a number, and a symbol.

6. The method of claim 1, wherein the braille code comprises a six bit binary code.

7. The method of claim 1, wherein the first computing device and the second computing device vibrate individually.

8. The method of claim 1, wherein the first computing device and the second computing device are paired with each other via a pre-defined communication technology.

9. The method of claim 1, wherein the first computing device comprises one of a handheld device and a wearable device.

10. The method of claim 1, wherein the second computing device comprises one of a handheld device and a wearable device.

11. A system comprising:
a first computing device; and
a second computing device in communication with the first computing device, wherein the first computing device comprising:
a user interface configured to:
receive one or more characters representing sensitive information related to a user;
a feedback application running on the first computing device and is configured to:
encode each character into a braille code, wherein the braille code is represented by a matrix;
for each character, convert the braille code into a first part and a second part;
providing a first vibration output corresponding to the first part of braille code via the first computing device; and
providing a second vibration output corresponding to the second part of the braille code via a second computing device, wherein the combination of the first vibration output and the second vibration output is sensed by the user to validate each character of the one or more characters.

12. The system of claim 11, wherein the one or more characters are input by the user.

13. The system of claim 11, wherein the one or more characters are received in the form of: a text message, an email and a chat message.

14. The system of claim 11, wherein the braille code matrix is of size 3×2.

15. The system of claim 11, wherein each of the first part of braille code and the second part of braille code is of size 3×1.

16. A method for providing non-auditory feedback for each character of sensitive information, the method comprising:
encoding each character of the sensitive information into a binary braille code;
for each character, dividing the braille code into a first part and a second part;
generating a vibration pattern corresponding to the first part of braille code and a second vibration pattern for the second part of braille code; and
providing the first vibration pattern to the user via a first computing device and the second vibration pattern via a second computing device,
wherein the first vibration pattern and the second vibration pattern enables the user to recognize each character of the sensitive information.

17. The method of claim 16, wherein the binary code is a six digit binary code.

18. The method of claim 16, wherein the first computing device and the second computing device vibrate based on the first vibration pattern and the second vibration pattern, respectively.

19. The method of claim 16, wherein the sensitive information is received on the first computing device.

20. The method of claim 16, wherein the first vibration pattern is of a first pre-defined intensity and the second vibration pattern is of a second pre-defined intensity.

21. The method of claim 16, wherein providing the second vibration pattern comprises sending the second vibration pattern from the first computing device to the second computing device.
